(19) United States
(12) Patent Application Publication
(10) Pub. No.: US 2008/0075270 A1
(43) Pub. Date: Mar. 27, 2008

(54) DOUBLE-TALK DETECTION METHOD

(75) Inventor: Ken Kamiya, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI ELECTRIC INDUSTRY CO., LTD., Tokyo (JP)

(21) Appl. No.: 11/834,735

(22) Filed: Aug. 7, 2007

(30) Foreign Application Priority Data
Sep. 21, 2006 (JP) 2006-255537

(51) Int. Cl. H04M 9/08

(52) U.S. Cl. 379/406.08

(57) ABSTRACT

In an echo canceller that removes an echo of a far-end signal from a near-end signal by using an adaptive filter, when the far-end and near-end signals are both active, if the far-end signal level fails to exceed the near-end signal level by at least a first margin, filter adaptation is inhibited. If the far-end signal level exceeds the near-end signal level by at least the first margin, filter adaptation is enabled or inhibited, depending on the whether the difference between the far-end signal level and the residual signal level resulting from echo cancellation exceeds the double-talk detection threshold by at least a second margin, and the double-talk detection threshold is adjusted. The first margin enables double-talk to be detected accurately even before the adaptive filter coefficients have converged, or even when double-talk occurs continuously.

### BACKGROUND OF THE INVENTION

1. Field of the Invention

The present invention relates to a double-talk detection method for controlling the adaptive estimation of adaptive finite impulse response filter coefficients (tap coefficient updating) in an echo canceller.

2. Description of the Related Art

Two wires are used for the subscriber telephone lines connecting subscribers' telephone terminals to a telephone company's switching equipment, and four wires are used on the trunk lines beyond the switching equipment. Impedance mismatching at the hybrid coils that interface between the 2-wire and 4-wire lines generates unwanted echo paths, causing echoes. In hands-free telecommunication systems or teleconferencing systems, there are acoustic echo paths, similarly causing echoes. In order to prevent the degradation of call quality by annoying echoes, echo cancellers are indispensable.

An echo canceller generally comprises an adaptive finite impulse response (FIR) filter that generates an echo replica signal from the digitized far-end signal received from the far-end terminal, a subtractor that subtracts the echo replica signal from the digitized near-end signal input from the near-end terminal to generate a residual signal for transmission to the far end, and a double-talk detector.

The adaptive finite impulse response filter generates the echo replica signal from the far-end signal by calculations based on the estimated impulse response characteristic of the echo path and feeds the generated signal to the subtractor. The subtractor subtracts the echo replica signal from the near-end signal and outputs the resulting residual signal as near-end voice data. The residual signal is fed back to the adaptive finite impulse response filter, which adapts its estimate of the impulse response characteristic (by updating its tap coefficients) so as to minimize the power of the residual signal.

Adaptive estimation in the adaptive finite impulse response filter works well in the single-talk state in which only the far-end party is speaking, but is likely to work poorly in the double-talk state in which both parties speak at the same time, or in the state when the far-end terminal is silent.

A double-talk detector overcomes this problem by detecting the double-talk state and the state in which the far-end signal is inactive, and inhibiting the adaptation process in the adaptive finite impulse response filter in these states.

Japanese Examined Patent Application Publication No. 8-21881 describes a double-talk detector that detects the short-term average power of the far-end signal, the near-end signal, and the residual signal, generates logarithmic power values of these signals, makes various comparisons involving these power values, and thereby generates control signals that control the adaptive finite impulse response filter.

This double-talk detector comprises a subtractor for subtracting the residual power value from the far-end power value to generate a level difference signal, an adder for adding a margin γ to this level difference signal to generate a sum, a first comparator that detects the state in which the far-end signal is inactive by comparing the far-end power value with a first reference level, a second comparator that detects the state in which the near-end signal is inactive by comparing the near-end power value with a second reference level, a third comparator for comparing a preceding double-talk detection threshold value with the sum to generate a control signal that controls the adaptive finite impulse response filter, and a threshold value control unit that generates a double-talk detection threshold value according to the level difference signal, the sum, and the results obtained in the first to third comparators.

Because of the margin γ added to the level difference signal to generate the sum, the double-talk detector can adapt to small changes in the echo path.

When the first comparator detects the state in which the far-end signal is inactive, a control signal that inhibits adaptation in the adaptive finite impulse response filter is generated, and the updating of the double-talk detection threshold value in the threshold value control unit is inhibited. When the second comparator detects the state in which the near-end signal is inactive, the control signal is cleared, the double-talk detection threshold value is initialized, and the third comparator compares the double-talk detection threshold value with the sum to discriminate between the double-talk and single-talk states.

This configuration prevents the adaptation process in the adaptive finite impulse response filter from being disrupted by idle noise (non-speaking noise) and the like in the far-end signal, and enables various special cases, such as abrupt changes in the echo path caused by line hits and cases in which the echo path has a flat delay, to be detected so that the adaptation process in the adaptive finite impulse response filter can be enabled.

A problem with this double-talk detector is that if double-talk occurs before the adaptation process in the adaptive finite impulse response filter has converged, while the double-talk detection threshold is still low, the value of the sum becomes larger than the small double-talk detection threshold, the double-talk state is misrecognized as the single-talk state, and the adaptation process is disrupted.

Even after the adaptation process has converged and the double-talk detection threshold has been raised, if double-talk occurs continuously, it may be misrecognized as single-talk. During continuous double-talk, the adaptation process is temporarily inhibited and the double-talk detection threshold is reduced. If this state continues, eventually the double-talk detection threshold falls below the value of the sum, at which point the single-talk state is incorrectly recognized and the adaptation process resumes, disruptively.

Japanese Unexamined Patent Application Publication No. 2003-110469 discloses a double-talk detector that detects double-talk from the coding rates of voice codecs that code the far-end and near-end signals.

### SUMMARY OF THE INVENTION

An object of the present invention is to detect double-talk accurately even when double-talk occurs before the adaptation process has occurred, or when double-talk occurs continuously.

The invention provides a method of detecting double-talk in an echo canceller that receives a far-end signal having a far-end signal level and a near-end signal having a near-end signal level, uses an adaptive filter to generate an echo replica signal by estimating an impulse response of an echo path from the far-end signal to the near-end signal, subtracts the echo replica from the near-end signal to cancel an echo of the far-end signal in the near-end signal, transmits a resulting residual signal having a residual signal level, detects a double-talk state in which the far-end signal and the near-end signal are active simultaneously, and disables estimation of the impulse response during the double-talk state. The double-talk state is detected with reference to a detection threshold value.

When the far-end signal is inactive, estimation of the impulse response is inhibited and the detection threshold value is preserved unchanged.

When the far-end signal is active and the near-end signal is inactive, estimation of the impulse response is enabled and the detection threshold value is reduced.

When the far-end and near-end signals are both active, a first margin is added to the near-end signal level and the resulting first sum is compared with the far-end signal level. If the first sum is equal to or greater than the far-end signal level, estimation of the impulse response is inhibited and the detection threshold value is preserved unchanged. If the first sum is less than the far-end signal level, a second margin is added to a difference obtained by subtracting the residual signal level from the far-end signal level, the resulting second sum is compared with the detection threshold, estimation of the impulse response is enabled or inhibited depending on the result of the comparison, and the detection threshold value is updated.

When the far-end and near-end signals are both active, estimation of the impulse response is inhibited and the detection threshold value is preserved unless the far-end signal level exceeds the near-end signal level by at least the first margin. This feature enables double-talk to be detected accurately even before the estimate of the impulse response has converged, or even when double-talk occurs continuously.

### BRIEF DESCRIPTION OF THE DRAWINGS

In the attached drawings:

FIG. 1 is a block diagram of an echo canceller illustrating a first embodiment of the invention;

FIG. 2 is a block diagram showing an example of the structure of the threshold controller in FIG. 1;

FIG. 3 is a flowchart illustrating the operation of the double-talk detector in FIG. 1; and

FIG. 4 is a double-talk detection flowchart illustrating a second embodiment of the invention.

### DETAILED DESCRIPTION OF THE INVENTION

Embodiments of the invention will now be described with reference to the attached drawings, in which like elements are indicated by like reference characters.

### First Embodiment

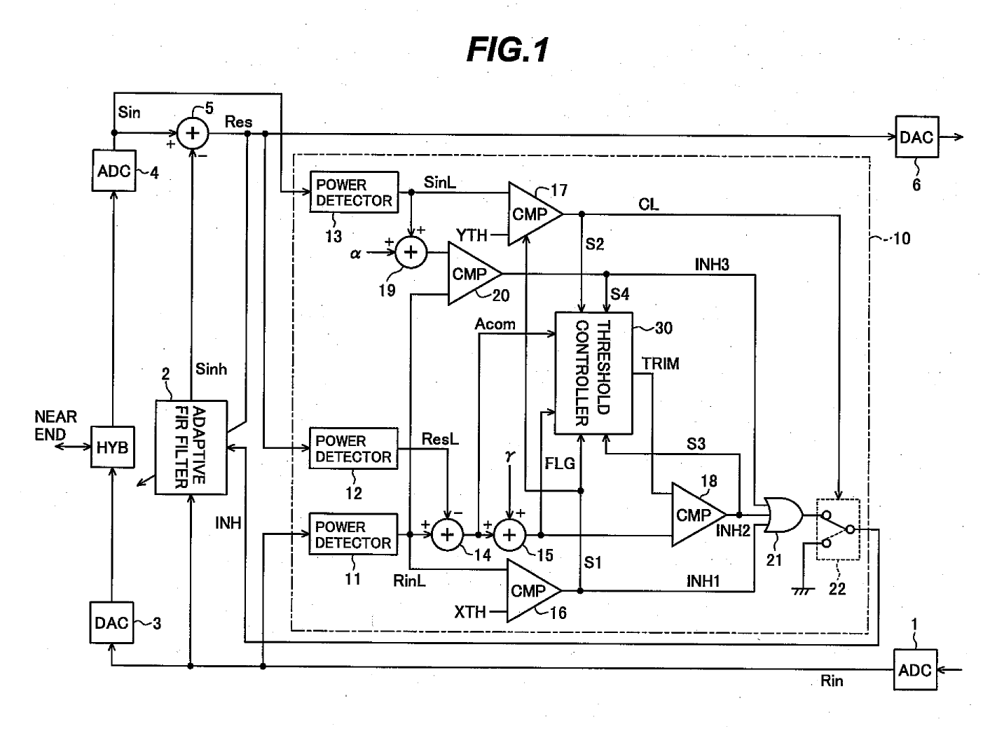

The first embodiment is illustrated by the echo canceller shown in FIG. 1, which comprises an analog-to-digital converter (ADC) 1 that receives a far-end voice signal and converts it to a digital far-end signal Rin, an adaptive finite impulse response filter (FIR) 2 that receives the digital far-end signal, and a digital-to-analog converter (DAC) 3 that converts the digital far-end signal back to an analog signal and supplies the analog far-end signal to a hybrid coil (HYB).

The hybrid coil has an impulse response that is modeled by tap coefficients in the adaptive finite impulse response filter 2. The adaptive finite impulse response filter 2 updates its tap coefficients by a known method so as to model the impulse response accurately, and applies the tap coefficients to the digital far-end signal Rin to generate an echo replica signal Sinh. Available methods of updating the tap coefficients include the well-known least mean squares (LMS) algorithm, the normalized least mean squares (NLMS) algorithm, and the recursive least squares (RLS) algorithm.

This echo canceller comprises an analog-to-digital converter 4 that receives a near-end voice signal through the hybrid coil and converts it to a digital near-end input signal Sin. The output terminal of the analog-to-digital converter 4 is connected to a subtractor 5. The subtractor 5 subtracts the echo replica signal Sinh from the near-end input signal Sin and generates the resulting residual signal Res. The residual signal Res is fed back to the adaptive finite impulse response filter 2, and to a digital-to-analog converter (DAC) 6 that converts the residual signal Res back to an analog voice signal and supplies the analog voice signal to the far end.

This echo canceller additionally comprises a double-talk detector 10 that generates an inhibit signal INH that controls adaptation, that is, estimation of the impulse response of the echo path, in the adaptive finite impulse response filter 2.

The double-talk detector 10 enables adaptation in the adaptive finite impulse response filter 2 in the single-talk state in which only the far-end party is speaking, but inhibits adaptation in the double-talk state in which both parties speak at the same time, and in any state when the far-end terminal is silent.

The double-talk detector 10 comprises power detectors 11, 12r and 13 that detect the short-term average power of the far-end input signal Rin, the residual signal Res, and the near-end input signal Sin, and generate a far-end input level RinL, a residual level ResL, and a near-end input level SinL, respectively. The output terminals of power detectors 11 and 12 are connected to a subtractor 14, and the output terminal of the subtractor 14 is connected to an adder 15 and a threshold controller 30. The subtractor 14 generates a level difference signal Acom by subtracting the residual level ResL from the far-end input level RinL and supplies the generated level difference signal Acom to the adder 15 and the threshold controller 30. The adder 15 adds a certain margin γ to the level difference signal Acom to calculate a sum FLG, and supplies the sum FLG to the threshold controller 30. Because of the margin γ added to the level difference signal Acom to calculate the sum FLG, the adaptive finite impulse response filter 2 can adapt to small changes in the echo path. The threshold controller 30 receives the level difference signal Acom and the sum FLG and generates a variable double-talk detection threshold value TRIM, as described below.

The output terminals of the power detectors 11 and 13 are connected to respective comparators (CMP) 16 and 17. Comparator 16 compares the far-end input level RinL with a reference value XTH to detect the state in which the far-end input signal Rin is inactive. When comparator 16 detects the silent state of the far-end input signal Rin, comparator 16 generates a signal INH1 that inhibits adaptation and an additional control signal S1. More specifically, when the far-end input level RinL is less than the reference value XTH (RinL<XTH), comparator 16 sets inhibit signal INH1 to the logic ‘1’ level to inhibit adaptation in the adaptive finite impulse response filter 2, and sets control signal S1 to the logic ‘1’ level to inhibit the updating of the double-talk detection threshold value TRIM in the threshold controller 30, thereby preventing estimation operations by the adaptive finite impulse response filter 2 from being disrupted by idle noise (non-speaking noise) and the like in the far-end input signal Rin.

When control signal S1 is inactive, comparator 17 compares the near-end input level SinL with a reference value YTH. If the near-end input level SinL is less than the reference value YTH (SinL<YTH), comparator 17 detects that the near-end input signal Sin is inactive, generates a clear signal CL that clears the signal INH that inhibits adaptation in the adaptive finite impulse response filter 2, and generates a control signal S2 that initializes the double-talk detection threshold value TRIM in the threshold controller 30 to, for example, zero. These operations by comparator 17 enable various special cases, such as abrupt changes in the echo path caused by line hits and cases in which the echo path has a flat delay, to be detected, so that the estimation operation by the adaptive finite impulse response filter 2 can be enabled. When control signal S1 is active, control signal S2 and the clear signal CL are held in the inactive state.

The output terminal of the adder 15 is connected to a comparator 18. Comparator 18 compares the preceding double-talk detection threshold value TRIM calculated by the threshold controller 30 with the sum FLG. When the preceding double-talk detection threshold value TRIM is equal to or greater than the sum FLG (TRIM≧FLG), comparator 18 detects the double-talk state and sets an inhibit signal INH2 to the logic ‘1’ level to inhibit adaptation in the adaptive finite impulse response filter 2; when the preceding double-talk detection threshold value TRIM is less than the sum FLG (TRIM<FLG), comparator 18 detects the single-talk state and sets inhibit signal INH2 to ‘0’. Comparator 18 also generates a control signal S3 that selects a method of controlling the double-talk detection threshold value TRIM according to the result obtained by discriminating between the double-talk and single-talk states, and supplies the generated control signal S3 to the threshold controller 30.

The output terminal of power detector 13 is connected to an adder 19 that adds a margin α calculated from the echo return loss to the near-end input level SinL. A comparator 20 compares the sum of the near-end input level SinL and the margin α (SinL+α) with the far-end input level RinL. Comparator 20 generates an inhibit signal INH3 and a control signal S4 according to the result, and supplies the generated control signal S4 to the threshold controller 30 and the generated inhibit signal INH3 to an input terminal of a three-input OR gate 21. The other two input terminals of the OR gate 21 receive inhibit signals INH1 and INH2 from comparators 16 and 18. The output terminal of the OR gate 21 is connected to a clearing circuit 22.

The clearing circuit 22 operates, for example, as a switch. The clearing circuit 22 normally outputs the signal received from the OR gate 21 as an inhibit signal INH to the adaptive finite impulse response filter 2; when the clearing circuit 22 receives the clear signal CL from comparator 17, the clearing circuit 22 is connected to ground and the output inhibit signal INH is tied to the ‘0’ logic level.

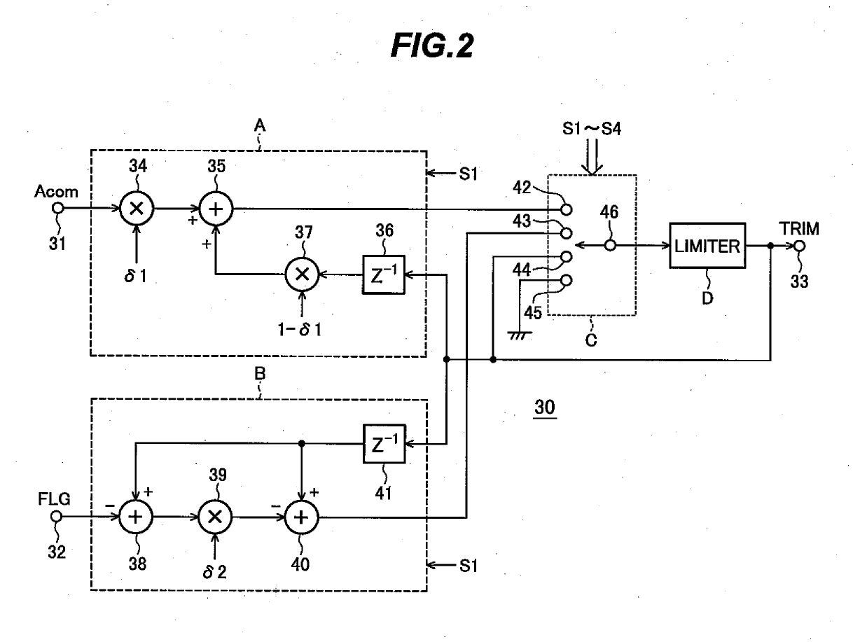

An example of the structure of the threshold controller 30 in FIG. 1 is shown in FIG. 2. This exemplary threshold controller 30 comprises an input terminal 31 that receives the level difference signal Acorn, an input terminal 32 that receives the sum FLG, and an output terminal 33 from which the double-talk detection threshold value TRIM is output. Circuits A and B are connected to input terminal 31 and input terminal 32, respectively, and the output terminals of circuits A and B are connected to the output terminal 33 via a selector C and a limiter D.

Circuit A, which integrates the level difference signal Acom, comprises a pair of multipliers 34, 37, an adder 35, and a unit delay element 36. The multiplier 34 multiplies the level difference signal Acom received at the input terminal 31 by a coefficient (δ1) to obtain a product (Acom·δ1), and supplies the product (Acom·δ1) to the adder 35. The unit delay element 36 has a delay time indicated as Z⁻¹ and holds a past value (for example, the preceding value) of the double-talk detection threshold value TRIM output from the output terminal 33. The multiplier 37 multiplies the past value of the double-talk detection threshold value TRIM by a coefficient (1−δ1) to obtain a product TRIM·(1δ1), and supplies the product TRIM·(1−δ1) to the adder 35. The adder 35 adds the product Acom·δ1 to the product TRIM·(1−δ1) and supplies their sum to the selector C.

Circuit B comprises a subtractor 38, a multiplier 39, a subtractor 40, and a unit delay element 41. The unit delay element 41 has the same delay time Z⁻¹ as the unit delay element 36 in circuit A, and holds the past value of the double-talk detection threshold value TRIM output from the output terminal 33. Subtractor 38 subtracts the sum FLG from this past value of the double-talk detection threshold value TRIM to obtain their difference (TRIM−FLG). Multiplier 39 multiplies the difference (TRIM−FLG) by a coefficient (δ2) to obtain a product (TRIM−FLG)·δ2. Subtractor 40 subtracts the product (TRIM−FLG)·δ2 from the previous value of the double-talk detection threshold value TRIM, and supplies the resulting difference to the selector C.

When the control signal S1 output from comparator 16 is ‘1’, circuits A and B halt the above calculations.

Selector C, which is controlled by control signals S1 to S4, comprises a terminal 42 connected to the output terminal of adder 35 in circuit A, a terminal 43 connected to the output terminal of subtractor 40 in circuit B, a terminal 44 that receives the double-talk detection threshold value TRIM output from the output terminal 33, a terminal 45 connected to ground, and a common terminal 46 connected to the input terminal of limiter D. When the control signal S1 output from comparator 16 is active (‘1’), selector C connects the common terminal 46 to terminal 44; when the control signal S1 output from comparator 16 is inactive (‘0’) and the control signal S2 output from comparator 17 is active (‘1’), selector C connects the common terminal 46 to terminal 45. If control signals S1 and S2 are both inactive (‘0’), then when control signals S3 and S4 are both ‘0’, selector C connects the common terminal 46 to terminal 42; when control signal S3 is ‘1’ and control signal S4 is ‘0’, selector C connects the common terminal 46 to terminal 43; when control signal S3 is either ‘1’ or ‘0’ and control signal S4 is ‘1’, selector C connects the common terminal 46 to terminal 44.

Limiter D limits the maximum value and minimum value of the double-talk detection threshold value TRIM.

Next, the operation of this echo canceller will be described.

Analog-to-digital converter 1 in the echo canceller receives a far-end voice signal and samples it to create a digital far-end input signal Rin. The double-talk detector 10 and the adaptive finite impulse response filter 2 receive the digital far-end input signal Rin, and digital-to-analog converter 3 converts the digital far-end signal back to an analog signal and supplies the analog far-end signal to the near end via the hybrid coil. Because impedance mismatching at the hybrid coil generates unwanted echo paths, and a loudspeaker and microphone may generate acoustic echo paths, the analog far-end signal is picked up at the near end. Analog-to-digital converter 4 samples the analog near-end input signal to create a digital near-end input signal Sin, and supplies the digital near-end input signal Sin to subtractor 5.

Subtractor 5 subtracts the echo replica signal Sinh from the near-end input signal Sin to generate a residual signal Res. Digital-to-analog converter 6 converts the residual signal Res back to an analog signal and supplies the analog signal as a near-end output signal to the far end. The residual signal Res is also fed back to the adaptive finite impulse response filter 2. When the adaptive finite impulse response filter 2 does not receive the inhibit signal INH from the double-talk detector 10, the adaptive finite impulse response filter 2 adapts its estimation of the impulse response characteristic of the echo path by updating its tap coefficients so as to minimize the power of the residual signal Res.

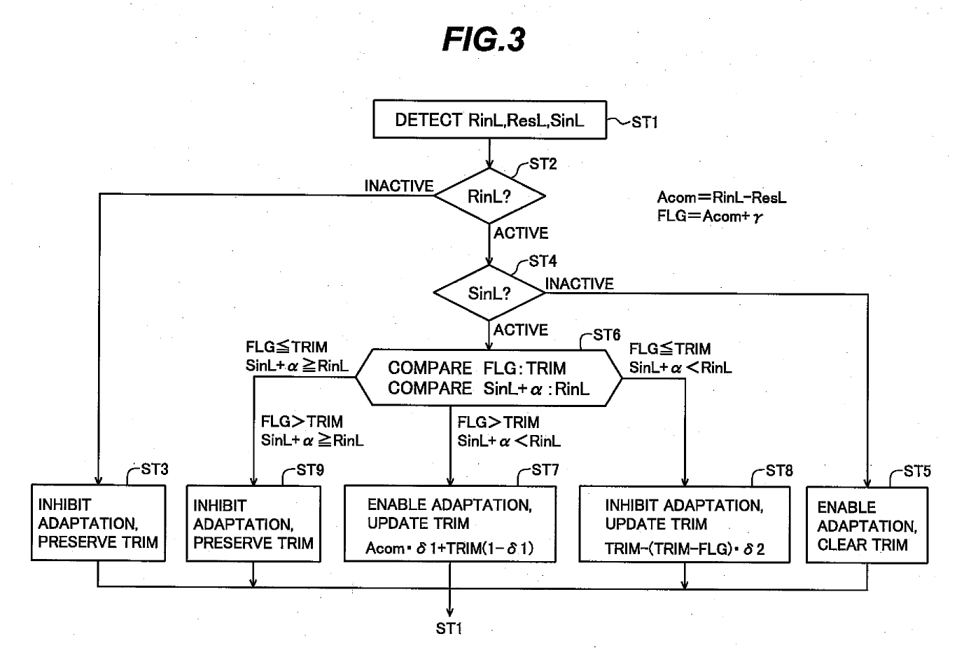

The operation of the double-talk detector 10 in FIG. 1 is illustrated in the flowchart in FIG. 3 and will be described below in detail.

In step ST1 in FIG. 3, the power detectors 11, 12, and 13 in the double-talk detector 10 in FIG. 1 detect the short-term average power of the far-end input signal Rin, the residual signal Res, and the near-end input signal Sin, and generate a far-end input level RinL, a residual level ResL, and a near-end input level SinL, respectively.

The subtractor 14 and comparators 16, 20 receive the far-end input level RinL; subtractor 14 receives the residual level ResL; comparator 17 and adder 19 receive the near-end input level SinL. Subtractor 14 generates the level difference signal Acom by subtracting the residual level ResL from the far-end input level RinL and supplies the level difference signal Acom to adder 15 and the threshold controller 30. Subtractor 15 adds the margin γ to the level difference signal Acom to calculate the sum FLG, and supplies the sum FLG to comparator 18 and the threshold controller 30. Adder 19 adds the margin α calculated from the echo return loss to the near-end input level SinL, and supplies the sum of the near-end input level SinL and the margin α (SinL+α) to comparator 20. The margin α is a fixed value corresponding to the calculated echo return loss. Respective comparators 16, 17, 18, and 20 perform the detection operations described below.

In step ST2, comparator 16 compares the far-end input level RinL with the reference value XTH to discriminate between the states in which the far-end input signal Rin is active and inactive. When the far-end input level RinL is less than the reference value XTH (RinL<XTH), comparator 16 detects the inactive state of the far-end input signal Rin, and the process goes to step ST3. When the far-end input level RinL is equal to or greater than the reference value XTH (RinL≧XTH), comparator 16 detects the active state of the far-end input signal Rin, and the process goes to step ST4.

In step ST3, comparator 16 sets inhibit signal INH1 and control signal S1 to the logic ‘1’ level. When inhibit signal INH1 is set to the logic ‘1’ level, the OR gate 21 sets inhibit signal INH1 to the logic ‘1’ level regardless of the results obtained by comparators 18 and 20. The clearing circuit 22 receives inhibit signal INH1, and supplies inhibit signal INH to the adaptive finite impulse response filter 2, inhibiting adaptation in the adaptive finite impulse response filter 2. Control signal S1 halts the operations of circuits A and B in the threshold controller 30 and inhibits the updating of the double-talk detection threshold value TRIM. The threshold controller 30 thereby preserves the preceding double-talk detection threshold value TRIM.

In step ST4, comparator 17 compares the near-end input level SinL with the reference value YTH to discriminate between the state in which the near-end input signal Sin is inactive and the state in which the signal Sin is active. When the near-end input level SinL is less than the reference value YTH (SinL<YTH), comparator 17 detects the inactive state of the near-end input signal Sin, and the process goes to step ST5. When the near-end input level SinL is equal to or greater than the reference value YTH (SinL≧YTH), comparator 17 detects the active state of the near-end input signal Sin, and the process goes to step ST6.

In step ST5, comparator 17 sets the clear signal CL and control signal S2 to the logic ‘1’ level. The clear signal CL clears the inhibit signal INH output from the clearing circuit 22 to the ‘0’ logic level, and the double-talk detector 10 enables adaptation in the adaptive finite impulse response filter 2. The control signal S2 initializes the double-talk detection threshold value TRIM to, for example, zero.

In step ST6, the results obtained by comparators 18 and 20 are tested. Comparator 18 compares the preceding double-talk detection threshold value TRIM with the sum FLG of the level difference signal Acom and the margin γ (Acom+γ). When the preceding double-talk detection threshold value TRIM is equal to or greater than the sum FLG (TRIM≧FLG=Acom+γ), comparator 18 sets inhibit signal INH2 and control signal S3 to the logic ‘1’ level; when the preceding double-talk detection threshold value TRIM is less than the sum FLG (TRIM<FLG=Acom+γ), comparator 18 sets inhibit signal INH2 and control signal S3 to ‘0’. Comparator 20 compares the sum of the near-end input level SinL and the margin a (SinL+α) with the far-end input level RinL. When the sum of the near-end input level SinL and the margin α is equal to or greater than the far-end input level RinL (SinL+α≧RinL), comparator 20 sets inhibit signal INH3 and control signal S4 to the logic ‘1’ level; when the sum of the near-end input level SinL and the margin α is less than the far-end input level RinL (SinL+α<RinL), comparator 20 sets inhibit signal INH3 and control signal S4 to ‘0’.

The OR gate 21 takes the logical OR of the inhibit signals INH1, INH2, and INH3 from comparators 16, 18, and 20, and supplies the resulting inhibit signal INH to the adaptive finite impulse response filter 2 through the clearing circuit 22. When the logical OR is ‘1’, the double-talk detector 10 detects the double-talk state and inhibits adaptation in the adaptive finite impulse response filter 2; when the logical OR is ‘0’, the double-talk detector 10 detects the single-talk state and enables adaptation in the adaptive finite impulse response filter 2.

The results obtained in comparators 16, 17, 18, and 20 are supplied to the threshold controller 30 as control signals S1 to S4, which control selector C in the threshold controller 30. The threshold controller 30 updates the preceding double-talk detection threshold value TRIM by using the level difference signal Acom or the sum FLG, and outputs the updated TRIM value through selector C and limiter D.

When control signal S1 is active (‘1’), the threshold controller 30 detects that the far-end input signal Rin is inactive, selector C connects the common terminal 46 to terminal 44, and the threshold controller 30 holds the preceding double-talk detection threshold value TRIM.

When control signal S2 is active (‘1’), the threshold controller 30 detects that the near-end input signal Sin is inactive, selector C connects the common terminal 46 to terminal 45, and the threshold controller 30 initializes the preceding double-talk detection threshold value TRIM to, for example, zero.

When neither control signal S1 nor control signal S2 is active (‘1’), selector C is controlled by control signals S3 and S4. When the results obtained in step ST6 are that the sum FLG is greater than the detection threshold value TRIM (FLG>TRIM) and the sum of the near-end input level SinL and the margin α is less than the far-end input level RinL (SinL+α<RinL), control signals S3 and S4 are both ‘0’, and the process goes to step ST7; when the sum FLG is equal to or less than the detection threshold value TRIM (FLG≦TRIM) and the sum of the near-end input level SinL and the margin α is less than the far-end input level RinL (SinL+α<RinL), control signal S3 is ‘1’ and control signal S4 is ‘0’, and the process goes to step ST8; when the sum of the near-end input level SinL and the margin α is equal to or greater than the far-end input level RinL (SinL+α≧RinL), control signal S4 is ‘1’ and the process goes to step ST9, regardless of whether control signal S3 is ‘1’ or ‘0’.

In step ST7, selector C connects the common terminal 46 to terminal 42, and selects the sum Acom·δ1+TRIM·(1−δ1) obtained in circuit A as the newly updated double-talk detection threshold value TRIM. The double-talk detection threshold value TRIM is therefore increased.

In step ST8, selector C connects the common terminal 46 to terminal 43, and selects the difference TRIM−(TRIM=FLG)δ2 obtained in circuit B as the newly updated double-talk detection threshold value TRIM. The double-talk detection threshold value TRIM is therefore reduced.

In step ST9, selector C connects the common terminal 46 to terminal 44 when control signal S3 is either ‘1’ or ‘1’.

After completing step ST3, ST5, ST7, ST8, or ST9, the process returns to step ST1, and repeats the same operation.

As described above, in the double-talk detector 10 in the first embodiment, comparator 20 compares the sum of the near-end input level SinL and the margin α (SinL+α) with the far-end input level RinL to generate inhibit signal INH3. The OR gate 21 takes the logical OR of inhibit signal INH3 and the inhibit signals INH1 and INH2 output from comparators 16 and 18, and generates the inhibit signal INH that inhibits adaptation in the adaptive finite impulse response filter 2. Even if double-talk occurs before the adaptation process in the adaptive finite impulse response filter 2 has converged, the double-talk detector 10 accordingly detects the double-talk state and prevents the adaptation process from being disrupted.

When the near-end input level SinL is equal to or greater than the far-end input level RinL, or the near-end input level SinL is less than the far-end input level RinL but the difference between them does not exceed the margin α, the threshold controller 30 preserves the double-talk detection threshold value TRIM, so even if continuous double-talk occurs, the double-talk detection threshold value TRIM cannot be reduced, the double-talk state cannot be misrecognized as the single-talk state, and the adaptation process is properly controlled.

In a variation of the first embodiment, comparison operations that are not needed are disabled to conserve power. Specifically, while the control signal S1 output by comparator 16 is active (‘1’), the other comparators 17, 18, and 20 do not operate and their outputs are low (‘0’). When the control signal S2 output by comparator 17 is active (‘1’), comparators 18 and 20 do not operate. When the control signal S2 output by comparator 20 is active (‘1’), comparator 18 does not operate.

### Second Embodiment

The echo canceller in the second embodiment has the same structure as in the first embodiment in FIG. 1, except that the double-talk detector 10 is realized by a general-purpose computing device such as a microprocessor or digital signal processor executing instructions stored in a machine-readable medium such as a semiconductor memory device.

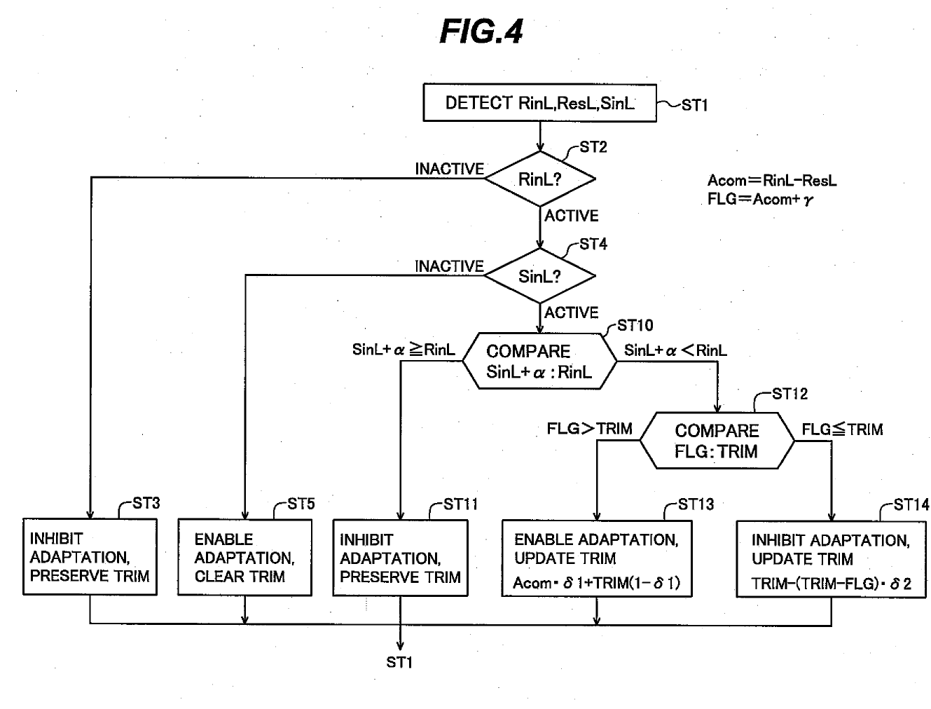

The second embodiment is illustrated by the double-talk detection flowchart in FIG. 4. Steps ST10 to ST14 in FIG. 4 replace steps ST6 to ST9 in FIG. 3. Steps ST1 to ST3 in FIG. 4 are identical the corresponding steps in FIG. 3, so descriptions will be omitted.

In step ST4, when the near-end input level SinL is less than the reference value YTH (SinL<YTH) and comparator 17 detects the inactive state of the near-end input signal Sin, the process goes to step ST5 as in FIG. 3 in the first embodiment. However, when comparator 17 detects the active state of the near-end input signal Sin in step ST4, the process goes to step ST10.

In step ST10, comparator 20 compares the sum of the near-end input level SinL and the margin α (SinL+α) with the far-end input level RinL. When the sum of the near-end input level SinL and the margin α is equal to or greater than the far-end input level RinL (SinL+α≧RinL), the process goes to step ST11. When the sum of the near-end input level SinL and the margin α is less than the far-end input level RinL (SinL+α<RinL), the process goes to step ST12.

In step ST11, comparator 20 detects the double-talk state, sets control signal S4 and inhibit signal INH3 to the logic ‘1’ level, and supplies control signal S4 to the threshold controller 30 and inhibit signal INH3 to the OR gate 21. The resulting active inhibit signal INH is supplied to the adaptive finite impulse response filter 2 via the clearing circuit 22, and inhibits adaptation in the adaptive finite impulse response filter 2. Control signal S4 inhibits the updating of the double-talk detection threshold value TRIM in the threshold controller 30.

In step ST12, the comparator 20 sets control signal S4 and inhibit signal INH3 to ‘0’, and supplies control signal S4 to the threshold controller 30 and inhibit signal INH3 to the OR gate 21. Comparator 18 compares the preceding double-talk detection threshold value TRIM with the sum FLG of the level difference signal Acom and the margin γ (Acom+γ). When the preceding double-talk detection threshold value TRIM is less than the sum FLG (TRIM<FLG Acom+γ), the process goes to step ST13. When the preceding double-talk detection threshold value TRIM is equal to or greater than the sum FLG (TRIM≧FLG=Acom+γ), the process goes to step ST14.

In step ST13, comparator 18 sets inhibit signal INH2 and control signal S3 to ‘0’, and supplies inhibit signal INH2 to the OR gate 21 and control signal S3 to the threshold controller 30. Selector C in the threshold controller 30 connects the common terminal 46 to terminal 42, and selects the sum Acom·δ+TRIM·(1−δ1) obtained in circuit A as the newly updated double-talk detection threshold value TRIM.

In step ST14, comparator 18 sets inhibit signal INH2 and control signal S3 to the logic ‘1’ level, and supplies inhibit signal INH2 to the OR gate 21 and control signal S3 to the threshold controller 30. Selector C in the threshold controller 30 connects the common terminal 46 to terminal 43, and selects the difference TRIM−(TRIM−FLG)·δ2 obtained in circuit B as the newly updated double-talk detection threshold value TRIM.

After completing step ST3, ST5, ST11, ST13 or ST14, the process returns to step ST1, and repeats the same operation.

In the second embodiment, since the comparisons and other operations are carried out sequentially by execution of instructions, unnecessary comparisons are automatically omitted, as in the variation of the first embodiment described above. Unnecessary addition and subtraction operations are also omitted, so in addition to the effects of the first embodiment, the second embodiment provides the effect of a reduced amount of computation.

The present invention is not limited to the preceding embodiments. For example, the margin α need not have a fixed value. The double-talk detector may include means for calculating the margin α according to the operation state. An exemplary method of calculating the margin α is to measure the echo return loss over a certain interval by using, for example, the coefficients of the adaptive finite impulse response filter 2 and the values calculated in the double-talk detector (the far-end input level RinL, the near-end input level SinL, and the residual level ResL) and calculate the margin α from the measured echo return loss. The double-talk detector can then detect double-talk more accurately in an environment such as a switching apparatus in which switching causes abrupt changes in the echo path, or an environment such as a hands-free telecommunication system in which there are constant small changes in the echo path.

Those skilled in the art will recognize that further variations are possible within the scope of the invention, which is defined in the appended claims.

What is claimed is:

1. A method of detecting double-talk in an echo canceller that receives a far-end signal having a far-end signal level and a near-end signal having a near-end signal level, uses an adaptive filter to generate an echo replica signal by estimating an impulse response of an echo path from the far-end signal to the near-end signal, subtracts the echo replica from the near-end signal to cancel an echo of the far-end signal in the near-end signal, transmits a resulting residual signal having a residual signal level, detects a double-talk state in which the far-end signal and the near-end signal are active simultaneously, and disables estimation of the impulse response during the double-talk state, the double-talk state being detected with reference to a detection threshold value, the method including:
a first process that inhibits the estimation of the impulse response and holds the detection threshold value unchanged when the far-end signal is inactive;
a second process that enables the estimation of the impulse response and reduces the detection threshold value when the far-end signal is active and the near-end signal is inactive; and
a third process carried out when the far-end and near-end signals are both active, wherein the third process adds a first margin to the near-end signal level to obtain a first sum, compares the first sum with the far-end signal level, inhibits the estimation of the impulse response and holds the detection threshold value unchanged if the first sum is equal to or greater than the far-end signal level, and if the first sum is less than the far-end signal level, adds a second margin to a first difference between the far-end signal level and the residual signal level to obtain a second sum, compares the second sum with the detection threshold value to decide whether to inhibit or enable the estimation of the impulse response, and updates the detection threshold value.

2. The double-talk detection method of claim 1, wherein:
if the second sum is greater than the detection threshold value the third process enables the estimation of the impulse response and increases the detection threshold value; and
if the second sum is equal to or less than the detection threshold value the third process inhibits the estimation of the impulse response and reduces the detection threshold value.

3. The double-talk detection method of claim 1, wherein:
if the second sum is greater than the detection threshold value, the third process enables the estimation of the impulse response, multiplies the first difference by a first coefficient to obtain a first product, multiplies the detection threshold value by a second coefficient to obtain a second product, and updates the detection threshold value to a sum of the first product and the second product; and
if the second sum is equal to or less than the detection threshold value, the third process inhibits the estimation of the impulse response, subtracts the second sum from the detection threshold value to obtain a second difference, multiplies the second difference by a third coefficient to obtain a third product, and updates the detection threshold value by subtracting the third product.

4. The double-talk detection method of claim 3, wherein the first coefficient and the second coefficient sum to unity.

5. The double-talk detection method of claim 1, further comprising:
measuring an echo return loss; and
calculating the first margin from the measured echo return loss.

6. A machine-readable medium storing instructions executable by a computing device in an echo canceller to detect double-talk by the method of claim 1.

7. A double-talk detector comprising the machine-readable medium of claim 6 and a computing device for executing the instructions stored in the machine-readable medium.

8. An echo canceller comprising:
the double-talk detector of claim 7;
an adaptive filter controlled by the double-talk detector, for generating an echo replica signal from the far-end signal; and
a subtractor for subtracting the echo replica signal from the near-end signal.
